(19) United States
(12) Patent Application Publication
(10) Pub. No.: US 2008/0081898 A1
(43) Pub. Date: Apr. 3, 2008

(54) Polyester fiber compositions

(76) Inventors: Jeffrey S. Ross, Lancaster, PA (US); Dong Tian, Lancaster, PA (US); Gary A. Sigel, Millersville, PA (US)

Correspondence Address: Douglas E. Winters;Armstrong World Industries, Inc., 2500 Columbia Avenue,, P.O. Box 3001, Lancaster, PA, 17604-3001, US

(21) Appl. No.: 11/906,474

(22) Filed: Oct. 2, 2007

Related U.S. Application Data
(60) Provisional application No. 60/848,762, filed on Oct. 2, 2006.

(51) Int. Cl. C08G 63/183

(52) U.S. Cl. 528/308.6; 528/308

(57) ABSTRACT

Thermoplastic, high molecular weight polyester resin fibers comprise renewable components. Such fibers find utility in flooring applications including carpet fibers, non-woven fiber mats, and reinforcing fibers.

### BACKGROUND OF THE INVENTION

This invention relates to thermoplastic, high molecular weight polyester resin fibers comprising renewable components. Such fibers find utility in flooring applications including carpet fibers, non-woven fiber mats, and reinforcing fibers.

### SUMMARY OF THE INVENTION

An object of the invention is to provide a crystalline polyester fiber comprising an aromatic diacid component and a renewable aliphatic diacid component. Such a fiber may be used in flooring applications, such as carpet fibers, non-woven fiber mats, and reinforcing fibers.

### DETAILED DESCRIPTION OF THE INVENTION

In some embodiments, the thermoplastic, polyester resin has a number average molecular weight (Mn) of a least 5,000, and in other embodiments the polyester resins have a molecular weight (Mn) of at least 10,000.

In one embodiment, the polyester resin from which fibers are formed comprise aromatic and aliphatic diacid components and aliphatic diol components. In one embodiment the aromatic diacid component is terephthalic acid. In some embodiments, an amount of phthalic acid, phthalic anhydride or isophthalic acid may be used in combination with the terephthalic acid to control the crystalline melt temperature—Tm. In some cases an amount of trimellitic anhydride may also be used.

The aliphatic diacid and diol components preferably come from renewable sources and have a Biobased Content. Renewable aliphatic diacid and aliphatic diol components may include but are not limited to Bio-PDO (1,3-propanediol), 1,4-butanediol, sebacic acid, succinic acid, adipic acid, azelaic acid, glycerin and citric acid. To further increase the renewable content and to improve other properties, these materials may also be modified by reaction with epoxidized soybean, epoxidized linseed oil, or other natural oils, or by being mixed with epoxidized soybean, epoxidized linseed oil, or other natural oils.

The polyesters may be pre-reacted with epoxidized natural oils, or the reaction can by a dynamic vulcanization. Dynamic vulcanization is the process of intimate melt mixing of a thermoplastic polymer and a suitable reactive rubbery polymer to generate a thermoplastic elastomer. These reactions are particularly of interest for acid terminated polyesters.

Other diacid and diol components from renewable resources will become available as the need for renewable materials continues to grow. The diol components may also include diols which are branched or hindered to modify crystallinity in the final polyester fiber. These can include neopentyl glycol and glycerin.

Renewable components based on plants, animals, or biomass processes have a different radioactive C¹⁴ signature than those produced from petroleum. These renewable, biobased materials have carbon that comes from contemporary (non-fossil) biological sources. A more detailed description of biobased materials is described in a paper by Ramani Narayan, “Biobased & Biodegradable Polymer Materials: Rationale, Drivers, and Technology Exemplars,” presented at American Chemical Society Symposium, San Diego 2005; American Chemical Society Publication #939, June 2006.

The Biobased Content is defined as the amount of biobased carbon in the material or product as fraction weight (mass) or percent weight (mass) of the total organic carbon in the material or product. ASTM D6866 (2005) describes a test method for determining Biobased content.

In one embodiment, the high molecular weight polyester resin is crystalline and comprises a crystalline melting temperature Tm between about 100° C. and 150° C. In yet another embodiment, the polyester has a Tm greater than about 150° C. In yet another embodiment, the polyester resin has a Tm of at least 190° C. In another embodiment, the polyester compositions include modifying traditional thermoplastic aromatic polyester resins useful as fibers by the addition of an amount of a renewable aliphatic diacid to help control crystalline regions and Tm.

The thermoplastic, high molecular weight polyester resin may also be branched. For example, utilizing aliphatic alcohols that have more than two functional groups, such as glycerin, or aromatic acids having more than two functional groups such as trimellitic anhydride may be used to produce branched polyesters.

Although, the above diacid components are described, it is understood that their simple diesters such as from methanol or ethanol can be used to prepare the thermoplastic, high molecular weight polyesters via known transesterification techniques.

The high molecular weight polyesters may be prepared by several known methods. One method involves esterification of a diacid and a diol components at elevated temperature. Typically, an excess of diol is employed (see Example 1A). After essentially all of the acid functional groups have reacted, a high vacuum is applied and excess diol is stripped off during transesterification, thereby increasing molecular weight. In some embodiments the diacid components comprise a mixture of aromatic diacid and renewable aliphatic diacid components. In some embodiments, renewable 1,3-PDO is the diol of choice to build high molecular weight in this step of the process.

It has also found that high molecular weight polyester resin can be made by esterification of a diacid and diol at elevated temperature using an excess of diacid (See example 1B). After all the hydroxyl groups are reacted, a high vacuum is applied to build molecular weight. The mechanism by which high molecular weight is achieved is not clear.

Another method for obtaining high molecular weight polyesters involves the co-reaction of a renewable polyester with recycle polyesters such as PET (polyethylene terephthalate), PBT (polybutylene terephthalate), PPT (polypropylene terephthalate) or other polyester resins. In these co-reactions an aliphatic polyester comprising renewable ingredients was first prepared as described in Example 1. In one embodiment, the aliphatic polyester has a Biobased Content of 100%. The recycle polyester resin was then mixed with the aliphatic polyester and transesterification between the two polyesters was accomplished at high temperature and preferably under high vacuum. In one embodiment, the polyester co-reaction resin product had a Tm between 100° C. and about 150° C. In another embodiment, the polyester co-reaction resin product has a Tm greater than about 150° C. In yet another embodiment, the polyester co-reaction resin product has a Tm greater than 190° C. It is obvious that these transesterification reactions may be carried out on virgin PET, PPT or PBT resin if desired.

Molecular weight of the polyester resins was determined by Gel Permeation Chromatography (GPC) using the following procedure. The polyester resin was dissolved into THF, quantitatively diluting to ˜30 mg/ml and filtering with a 0.45 micron filter. Two drops of toluene were added to each sample solution as an internal flow rate marker.

Samples soluble in THF were run by the following conditions. GPC analysis was run on the TriSec instrument using a four column bank of columns with pore sizes: 10⁶, 2 mixed D PLGel and 500 Angstroms. Three injections were made for the sample and calibration standards for statistical purposes. Universal Calibration (UC) GPC was used to determine MW. UC is a GPC technique that combines Refractive Index (RI) detection (conventional GPC) with Intrinsic Viscometry (IV) detection. Advantages of UC over conventional GPC are:

MW is absolute (not relative only to standards).

Yields information about branching of molecules.

The mobile phase for the THF soluble samples was THF at 1.0 ml/min. The data was processed using the Viscotek OmniSec UC software. The instrument is calibrated using a series of polystyrene narrow standards. To verify calibration, secondary standards were run. They include a 250,000 MW polystyrene broad standard, and a 90,000 MW PVC resin. The calculated molecular weight averages are defined as follows:

$$\begin{matrix}{M}_{n} = \frac{\sum ( {Area}_{i} )}{\sum ( {Area}_{i} ) / ( {M}_{i} )} \\ {M}_{w} = \frac{\sum [ ( {Area}_{i} ) \times ( {M}_{i} ) ]}{\sum ( {Area}_{i} )}\end{matrix}$$

$${M}_{2} = \frac{\sum [ {( {Area}_{i} )}^{2} \times ( {M}_{i} ) ]}{[ ( {Area}_{i} ) \times ( {M}_{i} ) ]}$$

$${Area}_{i} = The area of the {i}^{th} slice of polymer distribution$$

$${M}_{i} = The molecular weight of the {i}^{th} slice of polymer distribution$$

$$Polydispersity ( Pd ) = a number value used to describe the molecular weight distribution and is obtained by$$

$$Mw$$

$$Mn$$

Highly crystalline or some high molecular weight samples insoluble in THF were dissolved in a 50/50 (wt.) mixture of tetrachloroethylene (TTCE)/phenol. The column set is 104 and 500 Angstrom 50 cm Jordi columns. The mobile phase was 50/50 (wt.) mixture of TTCE/phenol at 0.3 ml/min. flow rate. The slower flow rate is due to the greater back pressure of the solvent system on the columns. The data was processed using the Viscotek UC OmniSec software.

Since MW data must be compared from one column set to the other, standards and selected samples were run on both column sets in THF for comparison. A calibration curve was made for each column set. There is good agreement of the standards between the two sets.

Fibers can be prepared from the above described polyester resins by any well known technique, including melt spinning techniques. Optimization of fiber physical properties by orientation and annealing techniques may also be employed. These fibers can be subsequently utilized in the manufacture of carpet products, non-woven fiber webs, and as reinforcing fibers.

### EXAMPLE 1

### Procedure for Preparation of High Molecular Weight Polyesters from Diacids and Diols

1A: This example describes the general procedure utilized to make thermoplastic, high molecular weight polyesters from diacids and diols. A desired polyester formulation was developed based upon mole equivalent weight of the diacid and diol functional groups. An excess of diol of the most volatile diol component of the formulation was employed in the formulation. In one embodiment, 1,3-propanediol is the excess diol of choice. The diacid and diol ingredients were added into a stainless steel vessel of a RC1 automated reactor (Mettler-Toledo Inc, 1900 Polaris Parkway, Columbus, Ohio), stirred and heated under a continuous flow of pure, dry nitrogen. Typically, the ingredients were heated to 200° C. for 2 hours and temperature increased to 230° C. for an additional 4 to 6 hours until essentially all acid end groups were reacted and theoretical amount of water removed. Subsequently, the nitrogen was stopped and a high vacuum was applied. The mixture was heat and stirred under high vacuum for an additional 4 or more hours at 230° C. to 300° C. In some cases the temperature of the transesterification step was increased to 250° C. or higher. Depending upon the experiment, a vacuum in the range of 5 mm of mercury was utilized. Subsequently, the polymer was allowed to cool to 150° C. to 200° C. and physically removed from the reactor under a flow of nitrogen and allowed to cool to room temperature.

It is understood that removal of the volatile diol component during transesterification leads to high molecular weight. High molecular weight may be obtained faster if higher vacuum (below 1 mm of mercury) is utilized. It is also known that as the melt viscosity increases due to increased molecular weight, the removal of diol becomes more difficult. The increase in molecular weight can become diffusion dependent because of the high viscosity of the molten polyester. This means that the released volatile diol from the transesterification reaction reacts back into the polymer before it can diffuse out of the melt, and be removed. Renewing the surface of the melt can facilitate the loss of diol and increase molecular weight. The polyesters obtained from this procedure generally have terminal hydroxyl end groups.

Although, diacid components are described above, it is understood that their simple diesters such as from methanol or ethanol can be used to prepare the thermoplastic polyester resin via known transesterification techniques. The polyesters from this procedure generally have ester terminated end groups.

1B: The same general procedure as in 1A is employed. A desired polyester formulation was developed based upon mole equivalent weight of the diacid and diol functional groups. An excess of around 0.01 to 0.5 mole excess of diacid was typically employed in the formulation. The ingredients were mixed and heated as in 1A above, except that the temperature was generally held below 200° C. to keep acid/anhydride from being removed until all hydroxyl groups were reacted. Subsequently, a high vacuum was applied as in 1A and the mixture heated to 230° C. and 280° C. and stirred as in Example 1A. The resultant high molecular weight polyester was removed from the reactor and cooled as in 1A.

The mechanism of achieving high molecular weight is not clear. In some formulations containing phthalic acid or anhydride, phthalic anhydride was identified as being removed from the mixture. The use of a nitrogen sparge below the surface of the molten polyester during the vacuum step also helped produce high molecular weight polyesters. The polyesters obtained from this procedure generally have terminal acid end groups.

### EXAMPLE 2

### Preparation of High Molecular Weight Polyesters by Co-Reaction with Recycle Crystalline Polyesters

The following formulation was processed as per Example 1A to prepare the aliphatic polyester EX-1 comprising 100% renewable components and a Biobased Content of 100%.

TABLE 1A

| | Ex-1 |
|---|---|
| 1,3-Propanediol | 400.5 |
| Sebacic acid | 600 |
| T-20 Catalyst | 0.4 |

The aliphatic polyester EX-1 was mixed with clear PET bottle recycle resin obtained from Nicos Polymers & Grinding of Nazareth, Pa., and catalyst added as listed below.

TABLE 1B

| | EX-2 |
|---|---|
| | Amt (g) |
| PET recycle bottle | 100 |
| EX-1 | 100 |
| T-20 Catalyst | 0.13 |

The mixture was heated and stirred under nitrogen at 265° C. for a period of about 3 hours, and a high vacuum applied as in Example 1A for an additional 3 hours at 265° C. Subsequently, the resultant polyester having 50% renewable content and 50% recycle content was shown to have a molecular weight Mn of 17,200 with a Tg of −9° C. and a Tm of 114° C. Molecular weight Mn of the starting PET recycle bottle resin was determined by GPC techniques described above and found to be 14,000. A sample of PET film obtained from Nicos Polymers & Grinding was also analyzed by GPC and molecular weight Mn determined to be 17,300.

### EXAMPLE 3

### Additional Polyesters Made by Transesterification Between High Molecular Weight Aliphatic, Renewable Polyesters and Recycle Polyester Resin

High molecular weight, renewable polyesters comprising the compositions of Table 2A were made according to Example 1A.

TABLE 2A

| | | 1,4- | Sebacic | | |
|---|---|---|---|---|---|
| | Azelaic Acid | Butanediol | Acid | T-20 | Total |
| | Amt (g) | Amt (g) | Amt (g) | Amt (g) | Amt (g) |
| Ex-1 | 674 | 325.74 | | 0.5 | 1000 |
| EX-2 | 511 | 489 | | 0.4 | 1000 |
| EX-3 | 582 | 417.6 | | 0.4 | 1000 |
| EX-4 | | 400.5 | 600 | 0.4 | 1001 |
| EX-5 | | 471.2 | 528 | 0.4 | 1000 |
| Ex-6 | | 354 | 529 | 0.4 | 883 |

The polyesters of Table 2A, were each mixed with recycle PET bottle resin obtained from Nicos Polymers & Grinding of Nazareth, Pa., and 0.1% T-20 catalyst added and transesterification conducted as per Example 1. In some examples, transesterification was also carried out on PBT resin Celanex 1600A obtained from Ticona (formerly Hoechst Celanese Corp.), Surnmit, N.J. Table 2B shows some of the resultant polyester co-reaction products and their Tm. The Tm of the resultant co-reaction product can be controlled by the ratio of the recycle polyester resin and the co-reactant polyester resin. It is obvious that these transesterification co-reactions may be carried out on virgin PET or PBT type resin.

TABLE 2B

| | Polyester | | | | | | | |
|---|---|---|---|---|---|---|---|---|
| PE | ID used in | Recycled | | | | | melt range | Mid-point |
| Transesterification | Transesterification | Bottle | PBT | PB | Ecoflex | PB | (° C.) trans | mp (Tm) |
| Rxn # | Rxn | PET | Celanex | Azelate | FBX7011 | Sebacate | product | ° C. |
| Nicos | | | | | | | 255-259 | 256 |
| Scrap PET | | | | | | | | |
| EX-8 | EX-3 | 70 | | 30 | | | 138-154 | 145 |
| EX-9 | EX-4 | 50 | | 50 | | | 84-105 | 94.9 |
| EX-10 | EX-4 | 70 | | 30 | | | 140-159 | 146 |
| EX-11 | EX-5 | 50 | | | | 50 | 99-126 | 102.9 |
| EX-12 | EX-5 | 70 | | | | 30 | 155-170 | 160 |
| EX-13 | EX-6 | 50 | | | | 50 | 101-125 | 109 |
| EX-14 | EX-6 | 70 | | | | 30 | 149-156 | 151 |
| EX-15 | EX-1 | 50 | | 50 | | | 100-111 | 105 |
| EX-16 | EX-1 | 70 | | 30 | | | 133-141 | 136 |
| EX-17 | EX-7 | 50 | | | | 50 | 92-106 | 97 |
| EX-18 | EX-7 | 70 | | | | 30 | 110-170 | 140 |
| EX-19 | EX-3 | | 75 | 75 | | | 135-141 | 137 |
| EX-20 | EX-7 | | 75 | | | 75 | 145-166 | 156 |
| EX-21 | EX-5 | 180 | | | | 120 | 79-153 | 87 |
| EX-22 | EX-1 | 180 | | 120 | | | 73-108 | 79 |
| EX-23 | Ecoflex | 180 | | | 120 | | 122-158 | 137 |
| | FXB7011 | | | | | | | |

Co-reacted polyesters with higher Tm may be produced by using less renewable, aliphatic polyester than described in the Table 2B above. The melting points listed in Table 2B were determined using an “Optimelt” automated unit. Theoretical Biobased Content was calculated for the above co-reacted products. The Biobased Content ranged from 56.5% to 58.3% for the 50:50 blends, and 35.8% to 37.5% for the 70:30 blends. The Biobased Content can be varied from about 5% by weight to 95% by weight.

Of course, non-recycled, virgin PET, PBT and PPT can be used instead of the recycled PET. In that case, the renewable resin should be at least 5% by weight.

### EXAMPLE 4

### Aromatic/Aliphatic Crystalline Polyester Preparation

Another approach to control the crystalline melting point (Tm) and degree of crystallinity in the polyesters useful as fibers, is to modify the traditional high Tm polyester fiber resins by incorporating aliphatic diacids into the polymer. Although any aliphatic diacid can be employed, it is preferred to utilize a diacid from renewable resources that has a Biobased Content. Two series of high molecular weight polyesters (Table 4A and 4B) were prepared according to Example 1A.

TABLE 3A

| Raw Material | EX-24 | EX-25 | EX-26 |
|---|---|---|---|
| Ingredient | Amt (g) | Amt (g) | Amt (g) |
| Sebacic acid | 127.03 | 127.03 | 148.16 |
| Terephthalic acid | 156.48 | 156.48 | 133.85 |
| Phthalic acid | | 13.04 | |
| Isophthalic acid | 13.04 | | 12.17 |
| 1,3-Propanediol | 119.49 | 119.49 | 111.5 |
| Glycerin | 4.82 | 4.82 | 4.5 |
| 1,6 Hexanediol | 27.83 | 27.83 | 25.97 |
| CHDm* | | | 12.6 |
| T-20 | 1.31 | 1.31 | 1.26 |
| Total | 450 | 450 | 450 |
| Tm(mid point) | 124 | 125 | 102 |

*cyclohexane dimethanol

Tm listed in Table 3A were determined the same as Example 2 using the Optimelt automated unit.

The series of high molecular weight polyesters of Table 3B was also prepared as per Example 1A. This table shows that Tm can be controlled by the addition of renewable diacid as described above, as well as addition of aromatic diacids that breakup the crystallinity of the resultant polyester.

TABLE 3B

| | EX-27 | EX-28 | EX-29 | EX-30 |
|---|---|---|---|---|
| Trade Name | Amt (g) | Amt (g) | Amt (g) | Amt (g) |
| 1,6-hexanediol | 156.41 | 0 | 0 | 0 |
| 1,3-propanediol | 137.86 | 257.74 | 219.19 | 249.61 |
| Terephthalic acid | 393.77 | 425.34 | 466.78 | 411.93 |
| Phthalic anhydride | 61.95 | 66.92 | 64.03 | 0 |
| Sebacic Acid | 0 | 0 | 0 | 88.46 |
| T-20 | 1.50 | 1.50 | 1.50 | 1.50 |
| Total | 751.48 | 751.50 | 751.50 | 751.50 |
| Tm(max)° C.** | 135 | 195 | 197 | 200 |

**The crystalline melting temperatures listed in Table 3B were determined by Differential Scanning Calorimetry (DSC) techniques.

The series of high molecular weight polyesters of Table 3C was also prepared as per Example 1A. This table shows that Tm can be controlled by the addition of renewable diacid as described above.

TABLE 3C

| Raw Material | EX-31 | EX-32 | EX-33 | EX-34 | EX-35 |
|---|---|---|---|---|---|
| Ingredient | Amt (g) | Amt (g) | Amt (g) | Amt (g) | Amt (g) |
| Sebacic acid | 304.55 | 94.97 | 387.72 | 314.53 | 277.15 |
| Terephthalic acid | 250.28 | 442.28 | 318.63 | 387.71 | 422.98 |
| CHDm* | 445.07 | 462.65 | | | |
| Bio-PDO | | | 288.84 | 298.89 | 294.95 |
| Glycerine | | | 4.71 | 4.78 | 4.81 |
| Fascat 4100 | 0.20 | | 0.10 | 0.10 | 0.10 |
| Fascat 2001 | | 0.6 | | | |
| Total | 1000.10 | 1000.50 | 1000.00 | 1000.01 | 999.99 |
| Tm(mid point) | 204 | 242 | 153 | 167 | 176 |

*cyclohexane dimethanol

1. A crystalline polyester fiber comprising an aromatic diacid component and a renewable aliphatic diacid component.

2. The polyester fiber of claim 1, further comprising a renewable diol component.

3. The polyester fiber of claim 1, wherein the melting point of the crystalline polyester is greater than 100° C.

4. The polyester fiber of claim 3, wherein the melting point of the crystalline polyester is greater than 150° C.

5. The polyester fiber of claim 4, wherein the melting point of the crystalline polyester is greater than 190° C.

6. The polyester fiber of claim 1, wherein the aromatic diacid comprises terephthalic acid.

7. The polyester fiber of claim 1, wherein the renewable aliphatic diacid is selected from the group consisting of sebacic acid, succinic acid, adipic acid, azelaic acid, citric acid, and mixtures thereof.

8. The polyester fiber of claim 2, wherein the renewable diol component is selected from the group consisting of to Bio-PDO (1,3-propanediol), 1,4-butanediol, glycerin, and mixtures thereof.

9. The polyester fiber of claim 1, wherein the polyester fiber has a Biobased Content of at least about 5%.

10. The polyester fiber of claim 9, wherein the polyester fiber has a Biobased Content of at least about 50%.

11. A crystalline polyester fiber comprising the co-reaction product of a crystalline polyester resin and a polyester resin having a renewable component.

12. The polyester fiber of claim 11, wherein the polyester fiber has a Biobased Content of at least about 5%.

13. The polyester fiber of claim 12, wherein the polyester fiber has a Biobased Content of at least about 50%.

14. The crystalline polyester fiber of claim 11, wherein the crystalline polyester resin comprises a recycle polyester resin.

15. The polyester fiber of claim 11, wherein the melting point of the crystalline polyester is greater than 100° C.

16. The polyester fiber of claim 15, wherein the melting point of the crystalline polyester is greater than 150° C.

17. The polyester fiber of claim 16, wherein the melting point of the crystalline polyester is greater than 190° C.

18. The polyester fiber of claim 14, wherein the polyester resin comprises at least 98% renewable components and recycle components.

19. The polyester fiber of claim 1, wherein the polyester resin has a number average molecular weight (Mn) of at least 5,000.

20. The polyester fiber of claim 1, wherein the polyester resin has a number average molecular weight (Mn) of at least 10,000.
